(19) United States
(12) Patent Application Publication
(10) Pub. No.: US 2009/0161700 A1
(43) Pub. Date: Jun. 25, 2009

(54) FIBER LASER

(75) Inventors: Kiminori Mizuuchi, Osaka (JP); Kazuhisa Yamamoto, Osaka (JP); Hiroyuki Furuya, Nara (JP); Akira Shirakawa, Tokyo (JP); Ken-ichi Ueda, Tokyo (JP)

Correspondence Address: GREENBLUM & BERNSTEIN, P.L.C., 1950 ROLAND CLARKE PLACE, RESTON, VA, 20191, US

(73) Assignees: MATSUSHITA ELECTRIC INDUSTRIAL CO., LTD., Osaka (JP); THE UNIVERSITY OF ELECTRO-COMMUNICATIONS, Tokyo (JP)

(21) Appl. No.: 12/096,056

(22) PCT Filed: Dec. 8, 2006
(86) PCT No.: PCT/JP2006/324510

§ 371 Date: Jun. 4, 2008

(30) Foreign Application Priority Data
Dec. 9, 2005 (JP) 2005-356288

(51) Int. Cl. H01S 3/30

(52) U.S. Cl. 372/6

(57) ABSTRACT

A fiber laser includes: a solid laser fiber doped with a rare earth element; a first grating fiber provided at one end portion of both ends along an optical axis direction of the solid laser fiber; and a first reflective element provided at the other end portion of the solid laser fiber. The first and second reflective elements constitute a resonator structure for the solid laser fiber; the first grating fiber Bragg-reflects only two polarizations of a first polarization having a first wavelength, and a second polarization having a second wavelength different from the first wavelength and being mutually orthogonal with the first polarization in a polarization direction; and at least one reflection wavelength of light which is reflected at the first reflective element and either one wavelength of the two polarizations which are Bragg-reflected at the first grating fiber coincide with each other.

### BACKGROUND OF THE INVENTION

1. Technical Field

The present invention relates to a fiber laser which outputs laser light of single polarization.

2. Background Art

A fiber laser having a core of a solid laser medium has been developing as a high power laser light source. The fiber laser includes a solid laser fiber having a core portion doped with an optically active rare-earth ion such as Nd, Yb, and Er; and optical reflective elements arranged with a predetermined distance spaced apart on both sides along an optical axis direction of the solid laser fiber. When pump light (excitation light) having a predetermined wavelength is made incident to the above solid laser fiber, rare-earth ion is excited to be a gain medium, and a resonator is constituted by the reflective elements; and accordingly, it becomes possible to perform laser oscillation. The reflective element needs to have characteristics which transmits the pump light and reflects the excitation light excited by the gain medium; and uses a grating fiber, which forms a periodical change in refractive index in the fiber and reflects a specific wavelength by Bragg-reflection, as the refractive element.

Further, there is proposed a method which uses a fiber laser as a light source of single polarization. As disclosed in Japanese Patent Laid-open Publication No. 11-501158, a laser medium is a polarized wave preserving fiber, the laser medium has a polarization dependent property, and loss for one polarization is large; and accordingly, it is configured to propagate only single polarization, as disclosed in Japanese Patent Laid-open Publication No. 11-501158 (corresponding to U.S. Pat. No. 5,511,083).

### SUMMARY OF THE INVENTION

The laser oscillation using a fiber amplifier can perform laser oscillation with high efficiency and high power. However, there is a problem in that a complicated configuration is required to control polarization and to emit light of single polarization.

The polarization control of such known fiber laser is a configuration in which loss of one polarization of the two different polarization components is increased and laser oscillation is performed in only a mode with small loss in a resonator. As conventional methods, there are a method which forms a periodic structure that increases loss for one polarization in the fiber introduced in the background art, and a method which inserts a polarizer transmitting through only one polarization therein. However, there are problems in that both methods are complicated in configuration, the number of components is increased, and adjustment becomes complicated; and consequently, there is a problem in simplification and reduction in cost.

An object of the present invention is to provide a fiber laser which controls polarization and performs single polarization. Further, another object of the present invention is to provide a light source using a fiber laser. Furthermore, another object of the present invention is to achieve a fiber laser light source which generates visible light by a single polarized fiber laser and a wavelength conversion element.

In order to solve the aforementioned problem, according to the present invention, there is provided a fiber laser including:

a solid laser fiber doped with a rare earth element;

a first grating fiber provided at one end portion of both ends along an optical axis direction of the solid laser fiber; and

a first reflective element provided at the other end portion of the solid laser fiber,

wherein the first and second reflective elements constitute a resonator structure for the solid laser fiber,

the first grating fiber Bragg-reflects only two polarizations: a first polarization having a first wavelength, and a second polarization having a second wavelength different from the first wavelength and being mutually orthogonal with the first polarization in a polarization direction, and

at least one reflection wavelength of light which is reflected at the first reflective element and either one wavelength of the two polarizations which are Bragg-reflected at the first grating fiber coincide with each other.

Furthermore, the first reflective element may be a dielectric multilayer film. Further, the first reflective element may be a reflective optical system in which light is retrieved from the other end portion of the solid laser fiber to the outside, and the reflected light is returned from the other end portion to the inside of the solid laser fiber. Still further, the first reflective element may be a second grating fiber which Bragg-reflects light having the same wavelength as either one polarization of the two polarizations that are Bragg-reflected at the first grating fiber.

Furthermore, the first reflective element may be a second grating fiber which Bragg-reflects only a third polarization having a third wavelength and a fourth polarization having a fourth wavelength different from the third wavelength and being mutually orthogonal with the third polarization in a polarization direction. In this case, either one polarization of two polarizations Bragg-reflected at the first grating fiber, and either one polarization of two polarizations Bragg-reflected at the second grating fiber coincide with each other in a polarization direction and Bragg-reflection wavelength.

Further, it may be such that the first and second grating fibers have each two mutually orthogonal polarizations;

a wavelength λ1 of the first polarization and a wavelength λ2 of the second polarization, both of which are Bragg-reflected at the first grating fiber, satisfy a relation of λ1>λ2; a wavelength λ3 of the third polarization and a wavelength λ4 of the fourth polarization, both of which are Bragg-reflected at the second grating fiber, satisfy a relation of λ3>λ4; and the wavelengths satisfy either a relation of λ1=λ4 or λ2=λ3.

Still further, the first wavelength of the first polarization which is Bragg-reflected at the first grating fiber and the fourth wavelength of the fourth polarization which is Bragg-reflected at the second grating fiber may coincide with each other. Alternatively, the second wavelength of the second polarization which is Bragg-reflected at the first grating fiber and the third wavelength of the third polarization which is Bragg-reflected at the second grating fiber may coincide with each other.

Yet further, it may be such that the solid laser fiber has a complex refractive index; and a polarization direction of the first grating fiber and a polarization direction of the solid laser fiber coincide with each other.

Furthermore, the solid laser fiber may have a complex refractive index. In this case, either one polarization of the two polarizations of the solid laser fiber, the first polarization of the first grating fiber, and the fourth polarization of the second grating fiber may coincide with one another.

Further, there may be further included a third grating fiber provided at one end portion of both ends of the first grating fiber in an optical axis direction, the one end portion being arranged on the opposite side of an end portion which comes in contact with the solid laser fiber; and a second reflective element provided at one end portion of both ends of the first reflective element in the optical axis direction, the one end portion being arranged on the opposite side of an end portion which comes in contact with the solid laser fiber. In this case, the first grating fiber and the first reflective element constitute a resonator structure for the solid laser fiber. Furthermore, the third grating fiber and the second reflective element constitute a resonator structure for the solid laser fiber. Further, the third grating fiber Bragg-reflects only two polarizations of a fifth polarization having a fifth wavelength and a sixth polarization having a sixth wavelength different from the fifth wavelength and being mutually orthogonal with the fifth polarization in a polarization direction. Still further, at least one reflection wavelength of light reflected at the second reflective element and a wavelength of either one polarization of the two polarizations which are Bragg-reflected at the third grating fiber may coincide with each other.

Furthermore, the second reflective element may be a dielectric multilayer film.

Still further, the second reflective element may be a fourth grating fiber which Bragg-reflects only a seventh polarization having a seventh wavelength and a eighth polarization having an eighth wavelength different from the seventh wavelength and being mutually orthogonal with the seventh polarization in a polarization direction. Furthermore, the third grating fiber and the fourth grating fiber may coincide with each other in a polarization direction and Bragg-reflection wavelength of one polarization of respective two polarizations to be Bragg-reflected.

Furthermore, the third and fourth grating fibers may have each two mutually orthogonal polarizations. In this case, it may be such that a wavelength λ5 of the fifth polarization and a wavelength λ6 of the sixth polarization, both of which are Bragg-reflected at the third grating fiber, satisfy a relation of λ5>λ6; a wavelength λ7 of the seventh polarization and a wavelength λ8 of the eighth polarization, both of which are Bragg-reflected at the fourth grating fiber, satisfy a relation of λ7>λ8; and the wavelengths satisfy either a relation of λ5=λ8 or λ6=λ7.

Further, the fifth wavelength of the fifth polarization which is Bragg-reflected at the third grating fiber and the eighth wavelength of the eighth polarization which is Bragg-reflected at the fourth grating fiber may coincide with each other. Alternatively, the sixth wavelength of the sixth polarization which is Bragg-reflected at the third grating fiber and the seventh wavelength of the seventh polarization which is Bragg-reflected at the fourth grating fiber may coincide with each other.

Further, the solid laser fiber may include at least one from a group including Yb, Er, Nd, Pr, Cr, Ti, V, and Ho.

Still further, the reflection wavelength of the light reflected at the first reflective element may be near 1060 nm. Furthermore, the reflection wavelength of the light reflected at the second reflective element may be near 1550 nm.

Further, there may be further included a wavelength conversion element which converts an output derived from the fiber laser to a harmonic. Still further, there may be further included a plurality of wavelength conversion elements which convert an output derived from the fiber laser to harmonics of a plurality of different wavelengths.

Furthermore, the wavelength conversion element may include at least one selected from a group of Mg doped LiNbO₃ having a periodic polarization inversion structure, Mg doped LiTaO₃, KTiOPO₄, Mg doped LiNbO₃ of stoichiometric composition, and Mg doped LiTaO₃ of stoichiometric composition.

Further, there may be further included a pump light source which inputs excitation light from either one end portion of the both sides of the solid laser fiber.

The fiber laser of the present invention proposes a method of controlling polarization of laser oscillation by making only one polarization set in a resonant state using characteristics of the grating fiber. Further, there are proposed applications to blue color, green color, simultaneous generation, an increase in output, and a display device.

According to the present invention, it becomes possible to perform polarization control and to perform single polarization by a simple configuration using a fiber laser. Further, a wavelength conversion element is used and single polarized light is wavelength-converted with high efficiency, whereby it becomes possible to generate visible light.

### BRIEF DESCRIPTION OF THE DRAWINGS

The present invention will become readily understood from the following description of preferred embodiments thereof made with reference to the accompanying drawings, in which like parts are designated by like reference numeral and in which:

FIG. 1A is a schematic diagram showing a configuration of a fiber laser according to a first embodiment of the present invention, and FIG. 1B is a schematic diagram showing a reflection spectrum characteristic by reflective elements on both sides of the fiber laser;

FIG. 2A is a schematic diagram showing a reflection spectrum characteristic of a sharp cut filter which transmits the long wavelength side and reflects the short wavelength side as a first reflective element of the fiber laser shown in FIG. 1, FIG. 2B is a schematic diagram showing a reflection spectrum characteristic of a filter having a narrowband reflection characteristic, and FIG. 2C is a schematic diagram showing a reflection spectrum characteristic of a band path filter having a narrowband transmission characteristic;

FIG. 3 is a schematic diagram showing a configuration of a fiber laser according to a second embodiment of the present invention;

FIG. 4A is a schematic diagram showing a configuration of a fiber laser according to a third embodiment of the present invention, and FIG. 4B is a schematic diagram showing a reflection spectrum characteristic by reflective elements on both sides of the fiber laser;

FIG. 5A is a schematic diagram showing a configuration of a fiber laser according to a fourth embodiment of the present invention, and FIG. 5B is a schematic diagram showing a reflection spectrum characteristic by reflective elements on both sides of the fiber laser;

FIG. 6A is a schematic diagram showing a configuration of a fiber laser according to a fifth embodiment of the present invention, and FIG. 6B is a schematic diagram showing a reflection spectrum characteristic by reflective elements on both sides of the fiber laser;

FIG. 7A is a schematic diagram showing a configuration of a fiber laser according to a sixth embodiment of the present invention, and FIG. 7B is a schematic diagram showing a reflection spectrum characteristic by reflective elements on both sides of the fiber laser;

FIG. 8A is a schematic diagram showing a configuration of a fiber laser according to a seventh embodiment of the present invention, and FIG. 8B is a schematic diagram showing a reflection spectrum characteristic by reflective elements on both sides of the fiber laser;

FIG. 9A is a schematic diagram showing a configuration of other fiber laser according to an eighth embodiment of the present invention, and FIG. 9B is a schematic diagram showing a reflection spectrum characteristic by reflective elements on both sides of the fiber laser;

FIG. 10 is a schematic diagram showing a configuration of a fiber laser according to a ninth embodiment of the present invention;

FIG. 11 is a schematic diagram showing a configuration of a fiber laser according to a tenth embodiment of the present invention;

FIG. 12A is a schematic diagram showing a configuration of a fiber laser according to a eleventh embodiment of the present invention, and FIG. 12B is a schematic diagram showing a configuration of a fiber laser of a different example;

FIG. 13 is a schematic diagram showing a configuration of a laser display device according to a twelfth embodiment of the present invention; and

FIG. 14 is a schematic diagram showing a configuration of a laser display device according to a thirteenth embodiment of the present invention.

### DETAILED DESCRIPTION OF THE PREFERRED EMBODIMENTS

Hereinafter, fiber lasers according to embodiments of the present invention will be described using the accompanying drawings. In addition, the same reference numerals are given to those substantially identical to elements shown in the drawings.

### First Embodiment

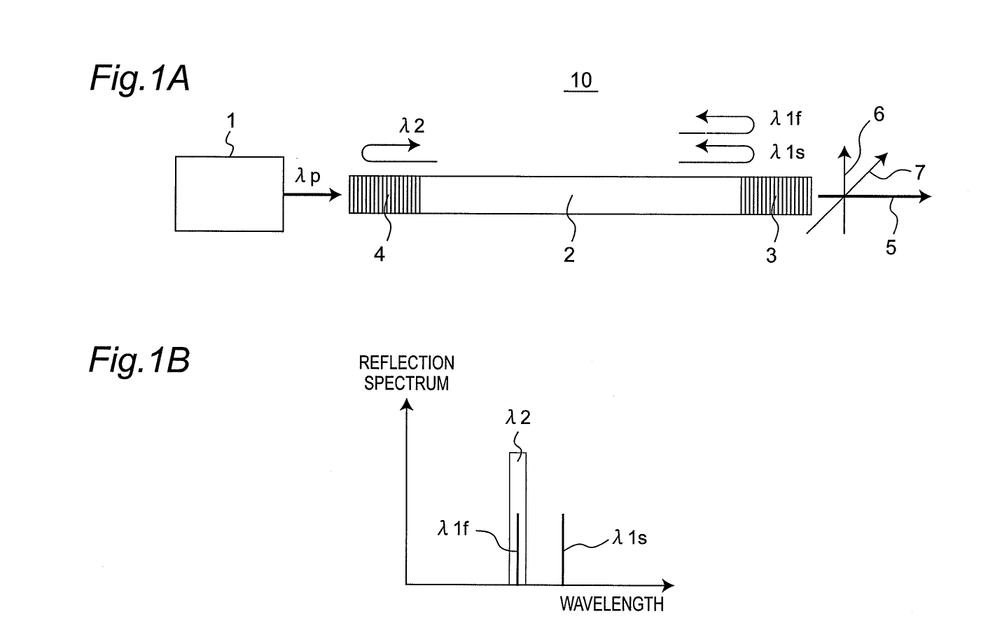

FIG. 1A is a schematic diagram showing a configuration of a fiber laser 10 according to a first embodiment of the present invention. FIG. 1B is a schematic diagram showing a relation between wavelengths of light and reflection spectra thereof, the light being reflected at reflective elements 3 and 4 on both sides along an optical axis direction of the fiber laser 10. The fiber laser 10 includes a solid laser fiber 2 doped with rare earth elements, and first and second grating fibers 3 and 4 provided on both sides of an optical axis direction of the solid laser fiber 2. The first and second grating fibers 3 and 4 constitute a resonator structure for the solid laser fiber 2. A first polarization 6 of a wavelength λ1f and a second polarization 7 of a wavelength λ1s are Bragg-reflected at the first grating fiber 3. In addition, as shown in FIG. 1, polarization directions of the first polarization 6 and the second polarization 7 are mutually orthogonal. Furthermore, light of the wavelength λ2 is Bragg-reflected at the second grating fiber 4. In this case, λ2 is set so as to coincide with λ1f. The fiber laser 10 can output single polarization 5 of the wavelength λ2 with which the reflection wavelengths at the first and second grating fibers 3 and 4 serving as the reflective elements on both sides coincide.

Next, the operating principle of the fiber laser 10 of the present invention will be described. Pump light having a predetermined wavelength λp emitted from the pump light source 1 is transmitted through the second grating fiber 4 and is made incident to the solid laser fiber 2. The pump light λp is absorbed in the solid laser fiber 2 and rare-earth ion is excited; and accordingly, the solid laser fiber 2 becomes an excited state. Further, the solid laser fiber 2 which becomes the excited state constitutes a resonator structure by the first and second grating fibers 3 and 4; and consequently, it becomes possible to perform laser oscillation. At this time, as shown in FIG. 1B, the reflection wavelength λ2 of the second grating fiber 4 is set to coincide with only either one of reflection wavelengths λ1s and λ1f of the first grating fiber 3. In the present first embodiment, λ2 is set to coincide with λ1f (λ2=λ1f). In the excitation light generated in the solid laser fiber 2, light having the wavelength λ2 reflected at the second grating fiber 4 coincides with the reflection wavelength λ1f of the first polarization 6 of two polarizations which are Bragg-reflected at the first grating fiber 3; and therefore, a resonant condition is satisfied by the refection due to this pair of reflective elements 3 and 4 and laser oscillation is performed. What becomes the laser oscillation state is the first polarization at the first grating fiber 3; and therefore, laser light 5 emitted from the first grating fiber 3 to the outside becomes light of single polarization of the wavelength λ2. Consequently, in the fiber laser 10, it becomes possible to output the single polarization 5 of the wavelength λ2 with which the reflection wavelengths at the first and second grating fibers 3 and 4 serving as the reflective elements on both sides coincide.

Further, respective constitutional members of the fiber laser 10 will be described.

First, the solid laser fiber 2 is doped with rare earth elements. Further, for example, at least one from a group including Ytterbium (Yb), Erbium (Er), Neodymium (Nd), Praseodymium (Pr), Chromium (Cr), Titanium (Ti), Vanadium (V), and Holmium (Ho) may be doped. Furthermore, a double clad fiber is preferable as the solid laser fiber 2. It becomes possible to produce high power excitation and to achieve high power laser oscillation by using the double clad fiber. Furthermore, the length of the solid laser fiber 2 is determined by an absorption coefficient of the pump light derived from the pump light source 1 in the solid laser fiber 2, and the length is set to absorb not less than approximately 80% or preferably approximately 100% of the pump light. For example, in the case where the solid laser fiber doped with Yb is used and the pump light having a wavelength of 915 nm is used, the length is approximately 10 m.

In addition, a polarized wave preserving fiber having a complex refractive index may be used as the solid laser fiber 2. An output can be stabilized by using a fiber with a complex refractive index. For example, when a disturbance is generated, there is a case where polarization in the fiber is changed and the output of the laser light 5 is fluctuated. In order to stabilize the output by preventing the output fluctuation due to such disturbance, it is preferable to use a polarized wave preserving fiber for the solid laser fiber 2. In addition, in the case where the polarized wave preserving fiber is used as the solid laser fiber 2, its polarization axis needs to coincide with the polarization axis of the first grating fiber 3.

Furthermore, the first grating fiber 3 uses a polarized wave preserving fiber having a complex refractive index. The polarized wave preserving fiber has refractive indices which are different depending on the polarization axes due to the complex refractive index of the fiber, and has polarizations of a first mode and a slow mode with respect to two mutually orthogonal polarization axes. In the drawing, the first polarization 6 is the first mode and the second polarization 7 is the slow mode. Propagation constants are different because refractive indices are different depending on the respective polarizations; and consequently, there generates a difference in wavelength between Bragg-reflections due to the gratings. When the Bragg-reflection wavelength of the first mode of the first polarization is λ1f and the Bragg-reflection wavelength of the slow mode of the second polarization is λ1s, it becomes a relation of λ1s>λ1f. In the case of a normal polarized wave preserving fiber, the difference between λ1s and λ1f is approximately 0.4 nm; however, the difference between the Bragg wavelengths can be controlled by adjusting the difference between the complex refractive indices. A reflectivity of the first grating fiber 3 is approximately 10%.

Furthermore, the second grating fiber 4 uses a normal single mode fiber. Since the single mode fiber has not the complex refractive index, the Bragg-reflection wavelength is λ2. A reflectivity of the second grating fiber 4 is not less than 99%. In addition, it is also preferable that the second grating fiber 4 is the double clad fiber. The pump light derived from the wide-striped pump light source 1 can be efficiently introduced to the solid laser fiber 2 by using the double clad fiber.

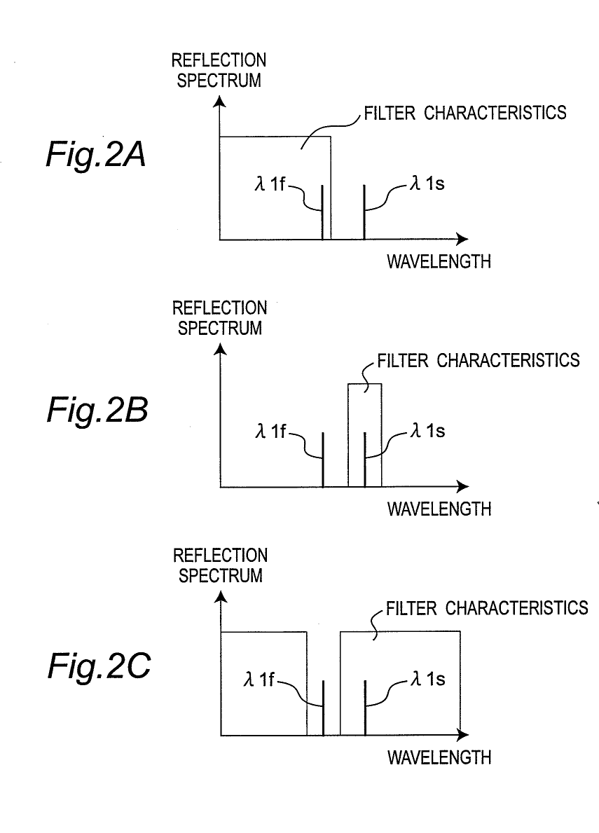

In addition, in this case, the second grating fiber 4 is used as the first reflective element; however, a dielectric multilayer film may be used in place of the grating fiber. The dielectric multilayer film can be achieved, for example, by adhering a multilayer mirror to an end surface of the solid laser fiber 2 or by directly depositing a multilayer film on the fiber end face. Some configurations shown in FIG. 2 can be used as the reflective elements using the dielectric multilayer film. A first configuration is a sharp cut filter which transmits the long wavelength side around the center of a specific wavelength and reflects the short wavelength side, as shown in FIG. 2A. If the configuration is made so as to transmit λ1s and reflect λ1f depending on magnitude relation between Bragg-reflection wavelengths of λ1s>λ1f, a resonant condition is satisfied by only the wavelength λ1f, and it becomes possible to perform laser oscillation in single polarization. A second configuration is a dielectric multilayer film having a narrowband reflection characteristic like the Bragg-reflection, as shown in FIG. 2B. In this case, since only a specific wavelength is reflected, it becomes possible to perform laser oscillation in single polarization when the reflection wavelength is made to coincide with either one of λ1s or λ1f. A third configuration is a band path filter having a narrowband transmission characteristic, as shown in FIG. 2C. In this case, when a narrowband transmission wavelength is made to coincide with either wavelength λ1s or wavelength λ1f laser oscillation is performed at only a wavelength which does not coincide therewith; and therefore, it becomes possible to perform laser oscillation of single polarization.

Further, the first reflective element may be achieved as an external reflective optical system. In this case, the dielectric multilayer film may be used as a bulk optical system. The external reflective optical system can be achieved as an optical system in which light is retrieved from the end surface of the solid laser fiber 2 to the outside; after collimating the light by a lens, for example, the light is reflected by a dielectric multilayer film filter; and the reflected light having a specific wavelength is returned to the inside of the solid laser fiber 2.

### Second Embodiment

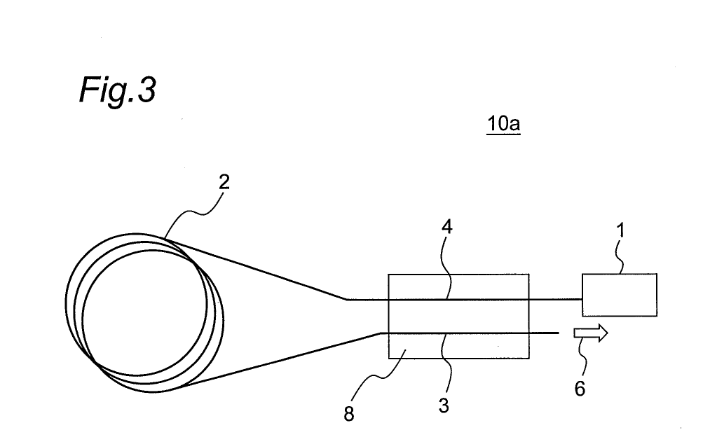

FIG. 3 is a schematic diagram showing a configuration of a fiber laser 10a according to a second embodiment of the present invention. The configuration of an optical system of the fiber laser 10a is the same as that of the fiber laser 10 shown in FIG. 1A. The fiber laser 10a is characterized in that a first grating fiber 3 and a second grating fiber 4 are arranged on a same substrate 8. The grating fibers 3 and 4 can be made under the same temperature condition, respectively, by arranging the first and second grating fibers 3 and 4 on the same substrate 8. Since the grating fiber changes its Bragg-reflection wavelength depending on the temperature condition, two grating fibers 3 and 4 are arranged on the same substrate 8 as described above; and accordingly, it becomes possible to prevent the reflection wavelengths on both ends from being deviated. Furthermore, it is preferable that the substrate 8 is a substance with good thermal conductivity such as aluminum, copper, silver, or the like.

### Third Embodiment

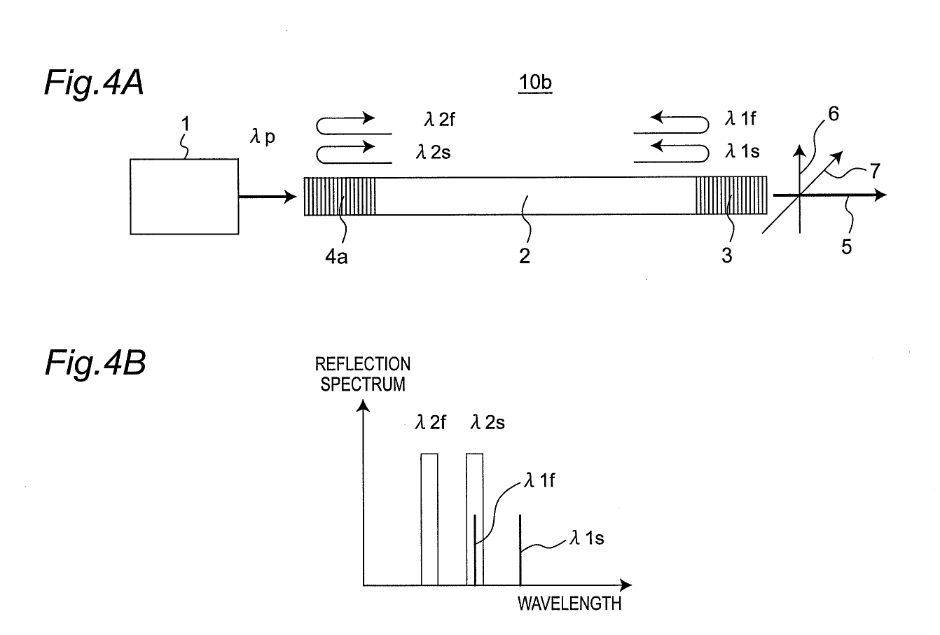

FIG. 4A is a schematic diagram showing a configuration of a fiber laser 10b according to a third embodiment of the present invention. FIG. 4B is a schematic diagram showing a reflection spectrum characteristic by reflective elements on both sides of the fiber laser 10b. The fiber laser 10b uses a polarized wave preserving fiber as a second grating fiber 4a. The polarized wave preserving fiber has different Bragg-reflection wavelengths λ2f and λ2s which are different in polarization. As shown in FIG. 4B, a Bragg wavelength λ1f of a first mode of a first grating fiber 3 is set to coincide with a Bragg-reflection wavelength λ2s of a slow mode of the second grating fiber 4a. With this configuration, a resonant condition comes into effect under a condition that the Bragg-reflection wavelengths are equal, and laser oscillation is performed. After that, laser light 5 of single polarization of a wavelength λ1f of a first polarization 6 can be outputted from the first grating fiber 3 to the outside. In the fiber laser 10b, the grating fibers 3 and 4a made up of the polarized wave preserving fibers are used as the reflective elements on both ends, a difference of the Bragg-reflection wavelengths between the respective polarizations is used, and the Bragg-reflection wavelengths in different modes are made to coincide; and accordingly, it becomes possible to perform single polarization of the laser light.

### Fourth Embodiment

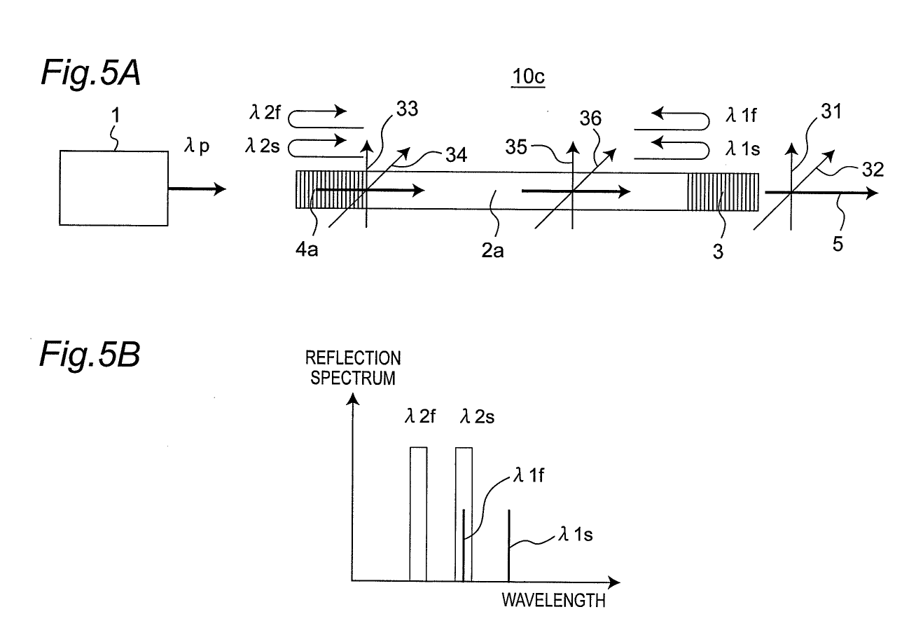

FIG. 5A is a schematic diagram showing a configuration of a fiber laser 10c according to a fourth embodiment of the present invention. FIG. 5B is a schematic diagram showing a reflection spectrum characteristic by reflective elements on both sides of the fiber laser 10c. The fiber laser 10c uses a polarized wave preserving fiber having a complex refractive index as a solid laser fiber 2a. An output can be stabilized by suppressing output fluctuation due to disturbance by using the fiber with the complex refractive index. For example, when a disturbance is generated, there is a case where polarization in the fiber is changed and the output of laser light 5 is fluctuated. In order to stabilize the output by preventing the output fluctuation due to such disturbance, it is preferable to use the polarized wave preserving fiber for the solid laser fiber 2a.

In addition, when the polarized wave preserving fiber is used as the solid laser fiber 2a, as shown in FIG. 5A, its polarization axis needs to coincide with a polarization axis of a first grating fiber 3. Further, respective grating fibers 3 and 4a need to be fused to the solid laser fiber 2a so that a first mode of the first grating fiber 3 and a slow mode of the second grating fiber 4a coincide with the same polarization axis of the solid laser fiber 2a.

Furthermore, a double clad fiber is preferable as the second grating fiber 4a. A high combination efficiency with a pump light source 1 can be achieved by using the double clad fibers and high power pump light can be entered to the solid laser fiber 2a.

In addition, it is preferable to provide the polarized wave preserving fiber capable of performing polarization control at an emitting portion of the fiber laser 10c. Light to be outputted can perform single polarization by providing the polarized wave preserving fiber at the emitting portion.

### Fifth Embodiment

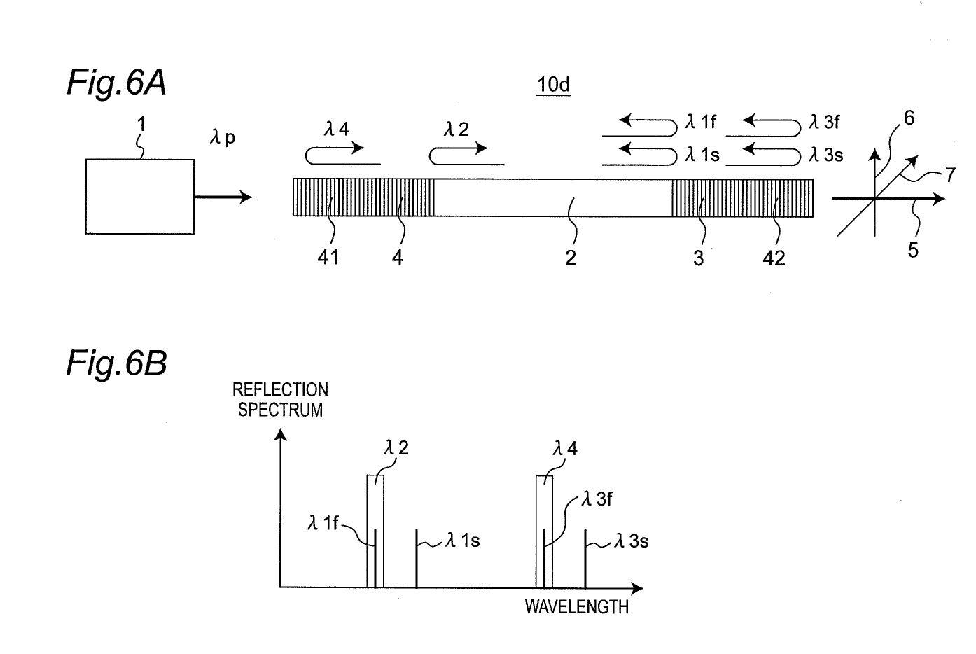

FIG. 6A is a schematic diagram showing a configuration of a fiber laser 10d according to a fifth embodiment of the present invention. FIG. 6B is a schematic diagram showing a reflection spectrum characteristic by reflective elements on both sides of the fiber laser 10d. According to the fiber laser 10d, it is possible to generate laser light of single polarization for each of a plurality of wavelengths. A configuration of the fiber laser 10d capable of generating such single polarizations of multiple wavelengths at the same time will be described using FIG. 6A. The fiber laser 10d is different in that a third grating fiber 42 and a fourth grating fiber 41 are further provided at both ends in an optical axis direction in addition to the configuration of the fiber laser 10 according to the first embodiment shown in FIG. 1A. The third grating fiber 42 is provided at an end portion opposite to the solid laser fiber 2 of both ends in an optical axis direction of the first grating fiber 3. Furthermore, the fourth grating fiber 41 is provided at an end portion opposite to the solid laser fiber 2 of both ends in an optical axis direction of the second grating fiber 4. A resonator structure is constituted by the third grating fiber 42 and the fourth grating fiber 41. In the third grating fiber 42, a first polarization 6 of a wavelength λ3f and a second polarization 7 of a wavelength λ3s are Bragg-reflected. In the fourth grating fiber 41, light of a wavelength λ4 is Bragg-reflected. In this case, λ4 is set to coincide with λ3f. In the fiber laser 10d, there can output single polarizations for two wavelengths of a first polarization 6 of a wavelength λ2 with which reflection wavelengths at the first and second grating fibers 3 and 4 serving as reflective elements on both sides coincide and a first polarization 6 of the wavelength λ4 with which reflection wavelengths at the third and fourth grating fibers 42 and 41 coincide.

Next, the operating principle of the fiber laser 10d will be described.

First, the third grating fiber 42 and the fourth grating fiber 41 have Bragg-reflection wavelengths which are different from the first and second grating fibers 3 and 4. The Bragg-reflection wavelengths are wavelengths which are different from Bragg-reflection wavelengths λ3f and λ3s of two different polarizations that are Bragg-reflected at the third grating fiber 42. On the other hand, the wavelength λ4 which is Bragg-reflected at the fourth grating fiber 41 coincides with only the wavelength λ3f of the first polarization 6 which is Bragg-reflected at the third grating fiber 42. Thus, in the fiber laser 10d, laser light having single polarizations of different wavelengths λ2 and λ4 can be outputted at the same time. For example, in the case where a fiber laser doped with Yb is used as the solid laser fiber 2, it is possible to generate excitation light in a wide wavelength range from 1030 to 1100 nm; and therefore, laser oscillation at a plurality of wavelengths can be generated at the same time. Furthermore, in the case where a plurality of rare earth elements are doped as the solid laser fiber 2, for example, in the case where Er and Yb are doped at the same time, it becomes possible to generate light of wavelength near 1060 nm (1030 to 1100 nm) by Yb and light of wavelength near 1550 nm (1480 to 1600 nm) by Er at the same time.

In addition, in this case, the fourth grating fiber 41 is used as the second reflective element; however, other filter using a dielectric multilayer film can also be used.

### Sixth Embodiment

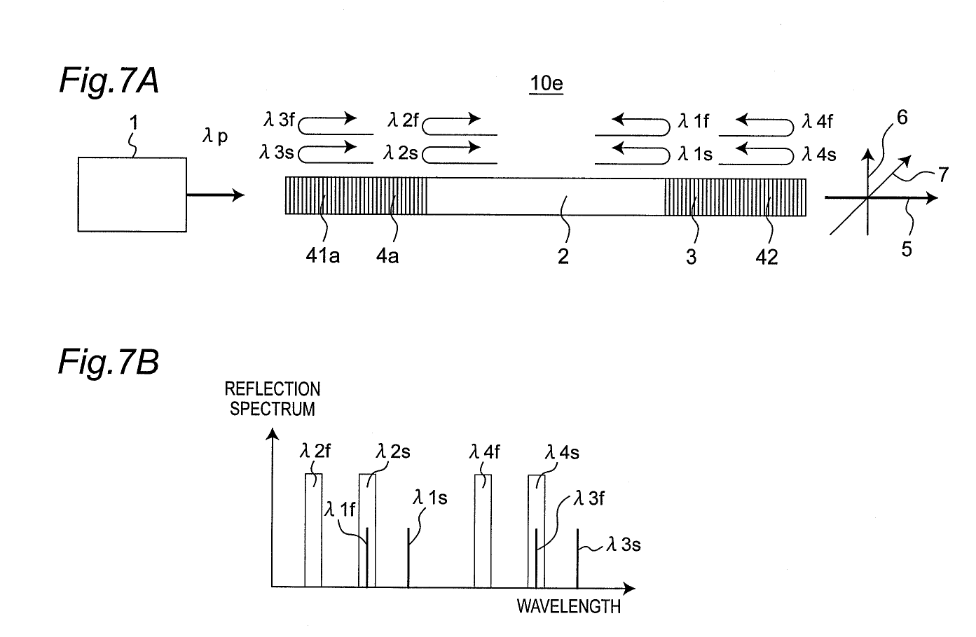

FIG. 7A is a schematic diagram showing a configuration of a fiber laser 10e according to a sixth embodiment of the present invention. FIG. 7B is a schematic diagram showing a reflection spectrum characteristic by reflective elements on both sides of the fiber laser 10e. In the fiber laser 10e, a polarized wave preserving fiber is used as a second grating fiber 4a, and a polarized wave preserving fiber is used as a third grating fiber 41a. Single polarization is easily performed by using a difference between Bragg-reflection wavelengths with polarized waves of the third grating fiber 41a. As shown in FIG. 7B, a Bragg-reflection wavelength λ3f of a first mode of the third grating fiber 41a coincides with a Bragg-reflection wavelength λ4s of a slow mode of the fourth grating fiber 42; and accordingly, a resonant condition is satisfied in only one polarization and it becomes possible to generate in single polarization.

Further, when two wavelengths are made to perform laser oscillation at the same time, mode competition due to scramble for gains between the two oscillations is generated; and therefore, there is a case where an output becomes unstable. In order to suppress this, a design is made to oscillate at two oscillating wavelengths in different polarizations; and accordingly, combination between modes is reduced and an output can be stabilized. In order to achieve this state, it is desirable to provide a configuration in which polarization of a solid laser fiber 2 coincides with polarizations of first and fourth grating fibers 3 and 42 so that polarizations of modes for generating laser oscillation are mutually orthogonal. That is, it is preferable to use a polarized wave preserving fiber for the solid laser fiber 2. Further, it is preferable that a polarization axis of the solid laser fiber 2, polarization axes of the first and fourth grating fibers 3 and 42, and polarization axes of the second and third grating fibers 4a and 41a coincide therewith, respectively. With the above configuration, a stable condition can be satisfied by designing so that one polarization coincides with polarization directions of λ1f and λ2s and other polarization coincides with polarization directions of λ4s and λ3f.

### Seventh Embodiment

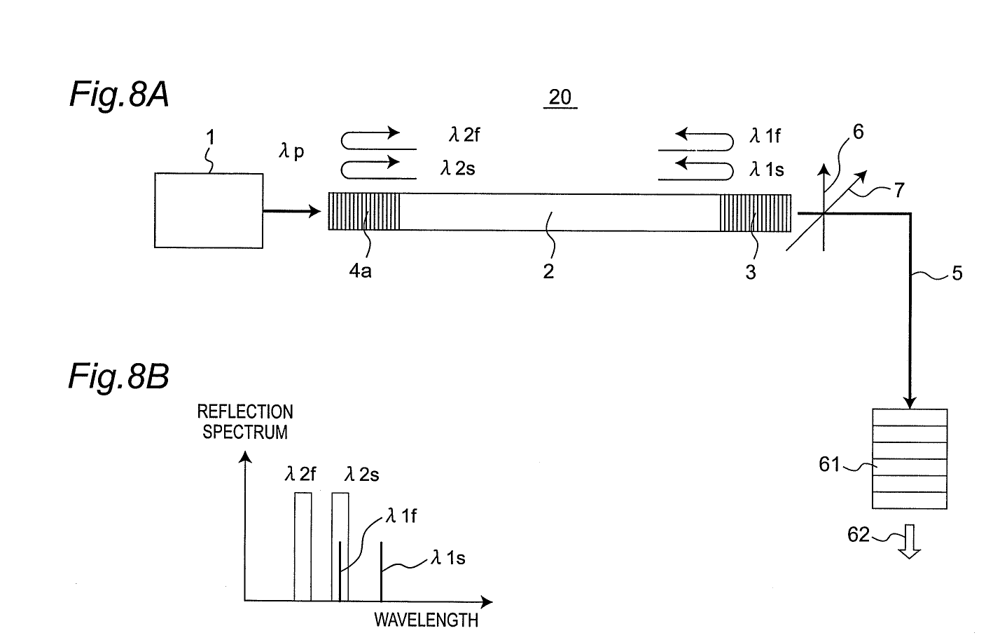

FIG. 8A is a schematic diagram showing a configuration of a fiber laser 20 according to a seventh embodiment of the present invention. FIG. 8B is a schematic diagram showing a reflection spectrum characteristic by reflective elements on both sides of a fiber laser 2 of the fiber laser 20. In the fiber laser 20, as compared with the fiber laser 10 according to the first embodiment, it is different in that a wavelength conversion element 61 which generates short wavelength light 62 form inputted laser light 5 is further provided therewith. In the fiber laser 20, single polarization can be generated by a simple configuration; and therefore, it becomes possible to perform highly efficient wavelength conversion by the wavelength conversion element 61. The wavelength conversion element 61 is provided at an emitting portion of the fiber laser 10, and the laser light 5 emitted from the fiber laser 10 by the wavelength conversion element 61 is converted to the harmonic 62.

Mg doped lithium niobate (LiNbO₃) having a periodic polarization inversion structure (PPMgLN) is used as the wavelength conversion element 61. The PPMgLN is a high nonlinear material having a high nonlinear constant, and it becomes possible to achieve highly efficient conversion. However, in order to perform highly efficient conversion, a fundamental wave to be inputted is required to have high beam quality. That is, in order to use the conversion element 61 using PPMgLN, there are required characteristics such as beam quality M2 of not higher than 1.2, a wavelength spectrum of not higher than 0.2 nm, and single polarization. In order to achieve high power characteristic while satisfying such characteristics, the configuration of the fiber laser 20 of the present invention is very effective. Spectrum width of the laser light can be controlled to not higher than 0.1 nm by narrowing permissible widths of Bragg-reflection wavelengths of two grating fibers. Furthermore, a polarization ratio of single polarization becomes not less than 15 dB by the fiber laser structure of the present invention. For this reason, conversion efficiency at the wavelength conversion element 61 can obtain a value close to the theoretical value, and conversion efficiency of not less than 30% can be easily obtained.

### Eighth Embodiment

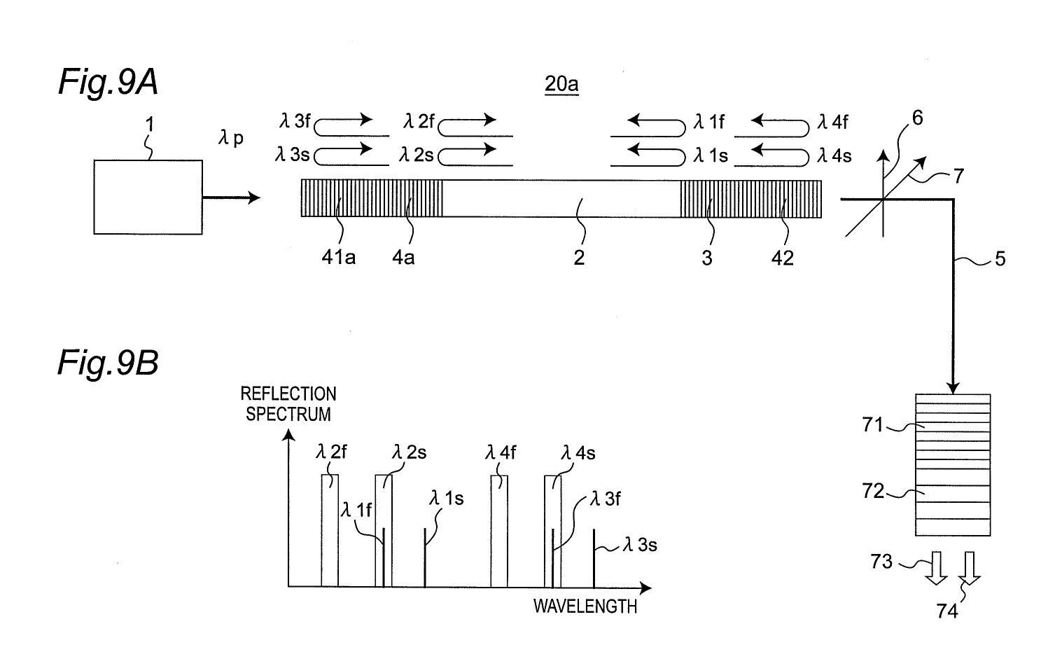

FIG. 9A is a schematic diagram showing a configuration of a fiber laser 20a according to an eighth embodiment of the present invention. FIG. 9B is a schematic diagram showing a reflection spectrum characteristic by reflective elements on both sides of a solid laser fiber 2 of the fiber laser 20. In the fiber laser 20a, wavelength conversion elements 71 and 72 are further combined with the configuration of the fiber laser 10e shown in FIG. 7A. As described above, two pairs of reflective elements of first and second grating fibers 3 and 4a and third and fourth grating fibers 42, 4a and 41a are used as the reflective elements on both sides; and accordingly, single polarization of multiple wavelengths can be generated. Laser light 5 of two wavelengths emitted from the fiber laser 10e are wavelength-converted to harmonics 73 and 74 by a wavelength conversion element 71 and a wavelength conversion element 72, respectively. The fiber laser 20a can generate different harmonics at the same time.

If light of a plurality of single polarizations can be generated from the fiber laser 20a as described above, field of application will be widened. For example, in the case where light having two wavelengths λ1 and λ2 is outputted, the light is divided into three wavelengths λ1/2, λ2/2, and λ1λ2/(λ1+λ2) when the light is converted to harmonics by the wavelength conversion element. It becomes possible to output light having five wavelengths when putting together the fundamental waves, and application will be expanded as a multiple wavelength light source. Further, in the case of using as a display light source, speckle noise can be reduced because the number of wavelengths increases; and therefore, there is an advantage in that it becomes possible to provide a display with high image quality and less speckle noise.

### Ninth Embodiment

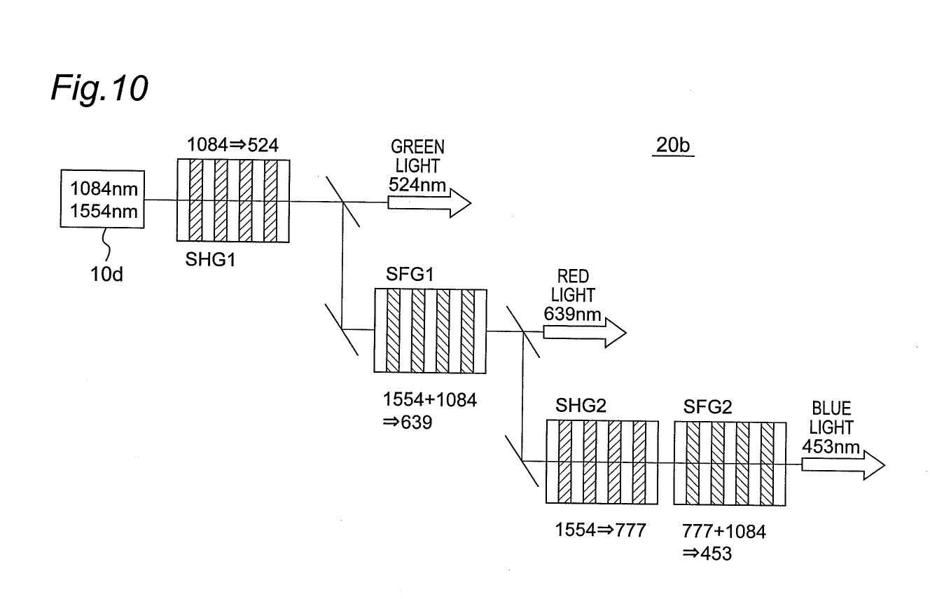

FIG. 10 is a schematic diagram showing a configuration of a fiber laser 20b according to a ninth embodiment of the present invention. In the fiber laser 20b, a plurality of wavelength conversion elements are further combined with a fiber laser 10d; and accordingly, red, blue, and green (RGB) light can be generated at the same time. The fiber laser 20b uses a solid laser fiber 2 doped with Er and Yb at the same time as a solid laser fiber. When light near 915 to 980 nm is used as a pump light source 1, it becomes possible to perform laser oscillation at two wavelengths with the configurations shown in FIG. 6A or FIG. 7A of the present invention. In this case, there will be described a case where light having wavelengths of 1084 nm and 1554 nm is generated at the same time. A part of the light having the wavelength of 1084 nm passed through an SHG1 is converted to a harmonic having a wavelength of 542 nm, and green light is generated. Further, non-converted light having the wavelength of 1084 nm and a part of light having the wavelength of 1554 nm are converted to sum-frequency mixing by an SFG1, and red light having a wavelength of 639 nm is generated. Further, the light having the wavelength of 1554 nm is converted to a harmonic having a wavelength of 777 nm by an SHG2, the light having the wavelength of 777 nm and the light having the wavelength of 1084 nm are converted to sum-frequency mixing by an SFG2, and blue light having a wavelength of 453 nm is generated. With this configuration, it becomes possible to generate three colors of RGB at the same time.

### Tenth Embodiment

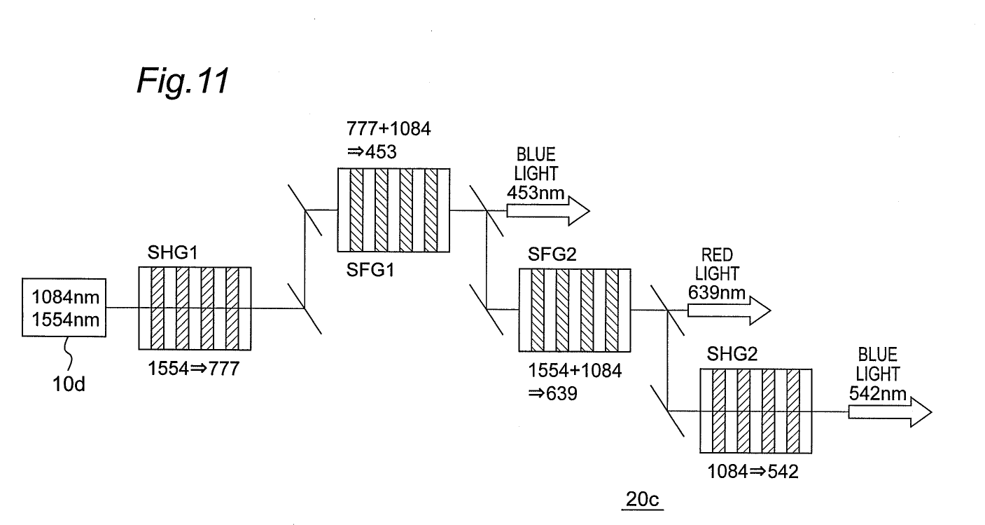

FIG. 11 is a schematic diagram showing a configuration of a fiber laser 20c according to a tenth embodiment of the present invention. As compared with the fiber laser according to the ninth embodiment, the fiber laser 20c is different in that wavelength conversion elements such as an SHG element and an SFG element are rearranged; however, it becomes possible to generate RGB at the same time as in the ninth embodiment. With the configuration of the present tenth embodiment, it becomes possible to generate a plurality of lights of single polarizations by a further simple configuration; and therefore, RGB light and multiple wavelength light can be easily generated.

### Eleventh Embodiment

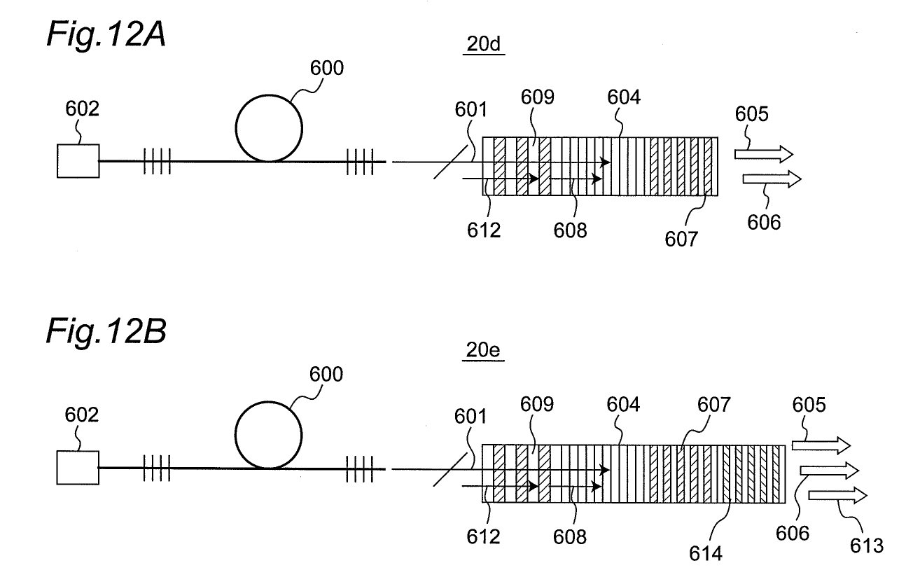

FIG. 12A is a schematic diagram showing a configuration of a fiber laser 20d according to an eleventh embodiment of the present invention. The fiber laser 20d is the configuration integrated with an SHG element and an SFG element. In the case of FIG. 12A, fundamental waves are a fundamental wave 601 having a wavelength of 1084 nm of single polarization and a fundamental wave 612 having a wavelength of 1554 nm. The fundamental wave 612 having the wavelength of 1554 nm is converted to a harmonic having a wavelength of 777 nm by an SHG element 609. Light having the wavelength of 777 nm and the fundamental wave 601 having the wavelength of 1084 nm are converted to blue light 605 having a wavelength of 453 nm by an SFG element 604. Further, the fundamental wave having the wavelength of 1084 nm is converted to green light 605 having a wavelength of 542 nm by an SHG element 607. In the fiber laser 20d, a wavelength conversion element is configured by a plurality of grating structures; and accordingly, it becomes possible to achieve that light of blue color and green color is generated at the same time. FIG. 12B is a schematic diagram showing a configuration of a fiber laser 20e of a different example. In the fiber laser 20e, an SFG element 614 is further provided in addition to the configuration shown in FIG. 12A, red light 613 having 642 nm is generated by sum-frequency mixing of the fundamental waves 601 and 612; and accordingly, it is possible to generate RGB light at the same time.

In the wavelength conversion element, the SHG and the SFG elements can be achieved by designing a polarization inversion cycle and these elements are configured to be integrated; and accordingly, the whole light source is reduced in size. Further, a loss in an optical system in mid-flow can also be reduced; and therefore, it is also effective to increase efficiency.

Furthermore, a wavelength conversion element made up of nonlinear optical crystal having a periodic polarization inversion structure is preferable as the SHG or SFG wavelength conversion element. As the wavelength conversion element having a polarization inversion structure, potassium titanyl phosphate (KTiOPO₄), LiNbO₃, lithium tantalate (LiTaO₃), Mg doped LiNbO₃, Mg doped LiTaO₃, Mg doped LiNbO₃ having stoichiometric composition, or Mg doped LiTaO₃ having stoichiometric composition, can be used. These crystals have a high nonlinear constant; and therefore, it is possible to perform wavelength conversion with high efficiency. Furthermore, there is an advantage in that a phase-matched wavelength can be freely designed by changing a periodic structure. It becomes possible to generate blue light by single optical crystal using the advantage.

In addition, it is possible to achieve even a configuration which includes any element of Nd, Pr, Cr, Ti, V, and Ho ion as a solid laser fiber in addition to the above mention. If an Nd doped fiber is used, it becomes easy to emit light near 1060 nm. Even in the case of using other ion, a light source of a different wavelength can be achieved.

### Twelfth Embodiment

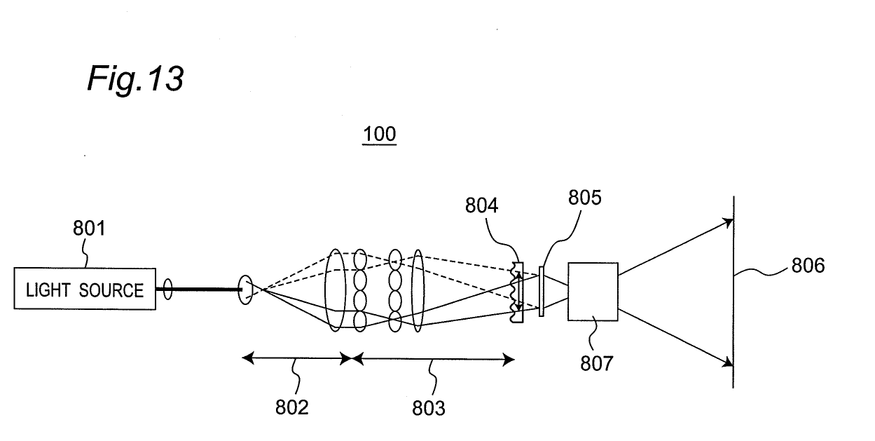

FIG. 13 is a schematic diagram showing a configuration of a laser display device 100 according to a twelfth embodiment of the present invention. In this case, the laser display device 100 serving as an optical device using a fiber laser that is a coherent light source of the present invention will be described. It becomes possible to achieve a laser display device with high color reproducibility by using an RGB laser which can be achieved by the above fiber laser of the present invention. In addition, as for a laser light source, a red semiconductor laser with high power has been developed; however, an increase in output for a blue color has not been achieved; and formation of a semiconductor laser for green color is difficult. Consequently, a green light source and a blue light source using wavelength conversion are required. According to the fiber laser serving as the coherent light source of the present invention, an increase in output is easy; and therefore, it becomes possible to achieve a large screen laser display device. It is possible to use a light source which generates green and blue, or green and blue at the same time as the light source using the fiber laser.

In the laser display device 100, as shown in FIG. 13, a fiber laser 801 serves as a light source; laser light is image-converted by a liquid crystal panel 805 serving as a two-dimensional switch; and a video picture is projected on a screen 806. More specifically, light emitted from the fiber laser 801 is passed through a collimating optical system 802, an integrator optical system 803, and a diffusion plate 804; after that, the light is image-converted by the liquid crystal panel 805 and is projected on a screen 806 by a projection lens 807. The diffusion plate 804 positionally fluctuates by a rocking mechanism, and reduces speckle noise generated on the screen 806. The fiber laser serving as the coherent light source of the present invention can also obtain a stable output with respect to a change in ambient temperature; and therefore, a high power and stable video picture can be achieved. Furthermore, it becomes possible to facilitate an optical system design and to perform reduction in size and simplification due to a high beam quality thereof.

In addition, a reflective liquid crystal switch, a digital micromirror device (DMD) mirror or the like can be used as the two-dimensional switch in addition to the liquid crystal panel.

### Thirteenth Embodiment

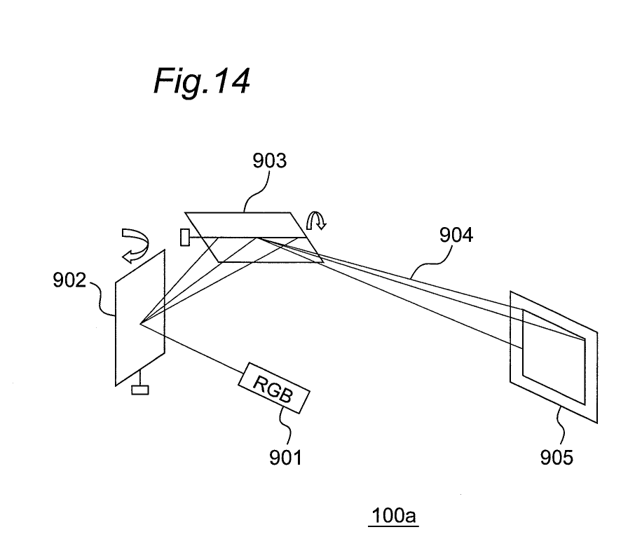

FIG. 14 is a schematic diagram showing a configuration of a laser display device 100a according to a thirteenth embodiment of the present invention. In the laser display device 100a, a two-dimensional image is depicted on a screen by scanning laser light with mirrors 902 and 903. In this case, a high-speed switch function is required for a laser light source. According to a fiber laser serving as a coherent light source of the present invention, it is possible to increase an output and it is excellent in output stabilization. Furthermore, a stable output can be obtained without using a temperature control element or by means of easy temperature control. Furthermore, it becomes possible to perform reduction in size and simplification of a scanning optical system due to a high beam quality thereof. Furthermore, a small scanning device using micro electro mechanical systems (MEMS) can also be used as a beam scanning optical system. The high beam quality is excellent in focusing characteristics and collimating characteristics, and it also becomes possible to use for a small mirror for MEMS or the like. This can achieve a scanning laser display.

Furthermore, in the present embodiment, the laser display is described as an optical device using the fiber laser; however, it is also effective to use the fiber laser according to the present invention for optical disk devices, measuring devices. An improvement in laser output by increasing writing speed is required for the optical disk device. Further, since a diffraction-limited focusing characteristic is required for laser light, it is indispensable to be a single mode. The light source using the fiber laser of the present invention has high power and high coherence; and therefore, application to optical disk devices is also effective.

In addition, if a visible light source using the fiber laser of the present invention is used, it also becomes possible to apply to a liquid crystal backlight. If the fiber laser is used as a light source for the liquid crystal backlight, liquid crystal with high efficiency and high luminance can be achieved by a high conversion efficiency. Further, since a wider color range can be expressed by laser light, a display excellent in color reproducibility can be achieved. Furthermore, if an RGB light source using the fiber laser of the present invention is used, RGB can be generated from a single light source at the same time; and therefore, there is also an advantage in that simplification of the configuration can be achieved.

Furthermore, the fiber laser of the present invention can also use as a lighting light source. The fiber laser is high in conversion efficiency; and therefore, it becomes possible to achieve high efficient conversion between electricity and light. Furthermore, light can be transferred to a separate place with low loss by using the fiber. Light is produced at a specified place and the light is transferred to a separate place; and accordingly, it becomes possible to provide room illumination by central generation of light. The fiber laser can combine with a fiber with low loss; and therefore, it is effective to deliver light.

The fiber laser of the present invention can generate laser light of single polarization by a simple configuration. Furthermore, it becomes possible to generate single polarization of a plurality of wavelengths. Further, it becomes possible to generate visible light and RBG light by combining with a wavelength conversion element.

Still further, if the fiber laser of the present invention is used, a high power and small RGB light source can be achieved; and therefore, it becomes possible to apply to various kinds of optical devices such as a laser display and an optical disk device.

1-23. (canceled)

24. A fiber laser comprising:
a solid laser fiber doped with a rare earth element;
a first grating fiber provided at one end portion of both ends along an optical axis direction of the solid laser fiber; and
a first reflective element provided at the other end portion of the solid laser fiber,
wherein the first grating fiber and the first reflective element constitute a resonator structure for the solid laser fiber,
wherein the first grating fiber Bragg-reflects only two polarizations of a first polarization having a first wavelength, and a second polarization having a second wavelength different from the first wavelength and being mutually orthogonal with the first polarization in a polarization direction, and
wherein at least one reflection wavelength of light which is reflected at the first reflective element and either one wavelength of the two polarizations, which are Bragg-reflected at the first grating fiber, coincide with each other.

25. The fiber laser according to claim 24,
wherein the first reflective element is a dielectric multilayer film which has a narrowband transmission characteristic at a wavelength λ0,
wherein the wavelength λ0 coincides with either one wavelength of two wavelengths Bragg-reflected at the grating fiber, the two Bragg-reflection wavelengths being mutually orthogonal in a polarization direction.

26. The fiber laser according to claim 24,
wherein the first reflective element is a dielectric multilayer film of a sharp cut filter which has a wavelength λ1 at a boundary,
wherein the wavelength λ1 is located between two wavelengths Bragg-reflected at the grating fiber, the two Bragg-reflection wavelengths being mutually orthogonal in a polarization direction.

27. The fiber laser according to claim 25,
wherein the first reflective element is a reflective optical system in which light is retrieved from the other end portion of the solid laser fiber to the outside; after that, the light is transmitted through the dielectric multilayer film; and then, the reflected light is returned from the other end portion to the inside of the solid laser fiber.

28. The fiber laser according to claim 24,
wherein the first reflective element is a second grating fiber which Bragg-reflects only a third polarization having a third wavelength and a fourth polarization having a fourth wavelength different from the third wavelength and being mutually orthogonal with the third polarization in a polarization direction; and
wherein either one polarization of two polarizations Bragg-reflected at the first grating fiber, and either one polarization of two polarizations Bragg-reflected at the second grating fiber coincide with each other in a polarization direction and Bragg-reflection wavelength.

29. The fiber laser according to claim 28,
wherein the first grating fibers has two mutually orthogonal polarizations, and the second grating fibers has two mutually orthogonal polarizations, respectively;
a wavelength λ1 of the first polarization and a wavelength λ2 of the second polarization, both of which are Bragg-reflected at the first grating fiber, satisfy a relation of λ1>λ2;
a wavelength λ3 of the third polarization and a wavelength λ4 of the fourth polarization, both of which are Bragg-reflected at the second grating fiber, satisfy a relation of λ3>λ4; and
the wavelengths satisfy either a relation of λ1=λ4 or λ2=λ3.

30. The fiber laser according to claim 28,
wherein the first wavelength of the first polarization which is Bragg-reflected at the first grating fiber and the fourth wavelength of the fourth polarization which is Bragg-reflected at the second grating fiber coincide with each other.

31. The fiber laser according to claim 28,
wherein the second wavelength of the second polarization which is Bragg-reflected at the first grating fiber and the third wavelength of the third polarization which is Bragg-reflected at the second grating fiber coincide with each other.

32. The fiber laser according to claim 24,
wherein the solid laser fiber has a complex refractive index; and
a polarization direction of the first grating fiber and a polarization direction of the solid laser fiber coincide with each other.

33. The fiber laser according to claim 28,
wherein the solid laser fiber has a complex refractive index; and
either one polarization of the two polarizations of the solid laser fiber, the first polarization of the first grating fiber, and the fourth polarization of the second grating fiber coincide with one another.

34. The fiber laser according to claim 24, further comprising:
a third grating fiber provided at one end portion of both ends of the first grating fiber in an optical axis direction, the one end portion being arranged on the opposite side of an end portion which comes in contact with the solid laser fiber; and
a second reflective element provided at one end portion of both ends of the first reflective element in the optical axis direction, the one end portion being arranged on the opposite side of an end portion which comes in contact with the solid laser fiber,
wherein the first grating fiber and the first reflective element constitute a resonator structure for the solid laser fiber,
wherein the third grating fiber and the second reflective element constitute a resonator structure for the solid laser fiber,
wherein the third grating fiber Bragg-reflects only two polarizations of a fifth polarization having a fifth wavelength and a sixth polarization having a sixth wavelength different from the fifth wavelength and being mutually orthogonal with the fifth polarization in a polarization direction, and
wherein at least one reflection wavelength of light reflected at the second reflective element and a wavelength of either one polarization of the two polarizations which are Bragg-reflected at the third grating fiber coincide with each other.

35. The fiber laser according to claim 34,
wherein the second reflective element is a dielectric multilayer film.

36. The fiber laser according to claim 34,
wherein the second reflective element is a fourth grating fiber which Bragg-reflects only a seventh polarization having a seventh wavelength and a eighth polarization having an eighth wavelength different from the seventh wavelength and being mutually orthogonal with the seventh polarization in a polarization direction; and
the third grating fiber and the fourth grating fiber coincide with each other in a polarization direction and Bragg-reflection wavelength of one polarization of respective two polarizations to be Bragg-reflected.

37. The fiber laser according to claim 36,
wherein the third and fourth grating fibers have each two mutually orthogonal polarizations;
a wavelength λ5 of the fifth polarization and a wavelength λ6 of the sixth polarization, both of which are Bragg-reflected at the third grating fiber, satisfy a relation of λ5>λ6;
a wavelength λ7 of the seventh polarization and a wavelength λ8 of the eighth polarization, both of which are Bragg-reflected at the fourth grating fiber, satisfy a relation of λ7>λ8; and
the wavelengths satisfy either a relation of λ5=λ8 or λ6=λ7.

38. The fiber laser according to claim 36,
wherein the fifth wavelength of the fifth polarization which is Bragg-reflected at the third grating fiber and the eighth wavelength of the eighth polarization which is Bragg-reflected at the fourth grating fiber coincide with each other.

39. The fiber laser according to claim 36,
wherein the sixth wavelength of the sixth polarization which is Bragg-reflected at the third grating fiber and the seventh wavelength of the seventh polarization which is Bragg-reflected at the fourth grating fiber coincide with each other.

40. The fiber laser according to claim 24,
wherein the solid laser fiber includes at least one from a group including Yb, Er, Nd, Pr, Cr, Ti, V, and Ho.

41. The fiber laser according to claim 24,
wherein the reflection wavelength of the light reflected at the first reflective element is near 1060 nm.

42. The fiber laser according to claim 34,
wherein the reflection wavelength of the light reflected at the second reflective element is near 1550 nm.

43. The fiber laser according to claim 24,
further comprising a wavelength conversion element which converts an output derived from the fiber laser to a harmonic.

44. The fiber laser according to claim 24,
further comprising a plurality of wavelength conversion elements which convert an output derived from the fiber laser to harmonics having a plurality of different wavelengths.

45. The fiber laser according to claim 43,
wherein the wavelength conversion element includes at least one selected from a group of Mg doped LiNbO₃ having a periodic polarization inversion structure, Mg doped LiTaO₃, KTiOPO₄, Mg doped LiNbO₃ of stoichiometric composition, and Mg doped LiTaO₃ of stoichiometric composition.

46. The fiber laser according to claim 24,
further comprising a pump light source which inputs excitation light from either one end portion of the both sides of the solid laser fiber.

47. The fiber laser according to claim 24,
further comprising a metal substrate with high thermal conductivity,
wherein the first reflective element is a second grating fiber which Bragg-reflects light having the same wavelength as either one polarization of the two polarizations which are Bragg-reflected at the first grating fiber, and
the first grating fiber and the second grating fiber are positioned proximate to the metal substrate.

48. The fiber laser according to claim 47,
wherein the grating fiber is a double clad fiber.

49. The fiber laser according to claim 24, further comprising:
a polarization-preserving solid laser fiber doped with Yb and Er;
first and fourth grating fibers provided at one end portion of both ends along an optical axis direction of the solid laser fiber; and
third and second grating fibers provided at the other end portion of the solid laser fiber,
wherein the first and second grating fibers constitute a resonator of a wavelength λ1 at only one polarization of the solid laser fiber, and
wherein the third and fourth grating fiber constitute a resonator of a wavelength λ2 at only the other polarization of the solid laser fiber.

50. The fiber laser according to claim 49, wherein the light of the λ1 and the light of the λ2 are mutually orthogonal in an polarization direction.

51. The fiber laser according to claim 50, wherein the wavelength λ1 is near 1550 nm, the wavelength λ2 is near 1660 nm.

52. The fiber laser according to claim 50, wherein the wavelength λ1 is near 1060 nm, the wavelength λ2 is near 1550 nm.
